(19) United States
(12) Patent Application Publication
(10) Pub. No.: US 2010/0108760 A1
(43) Pub. Date: May 6, 2010

(54) SYSTEM AND METHOD FOR TRACKING DISTRIBUTION OF ITEMS

(76) Inventor: Michael Wayne Eccleston, Grapevine, TX (US)

Correspondence Address: KENYON & KENYON LLP, ONE BROADWAY, NEW YORK, NY, 10004, US

(21) Appl. No.: 12/345,108

(22) Filed: Dec. 29, 2008

Related U.S. Application Data
(60) Provisional application No. 61/110,908, filed on Nov. 3, 2008.

(51) Int. Cl. G06F 19/00

(52) U.S. Cl. 235/385

(57) ABSTRACT

A method of tracking distribution of items, each item including an identification tag including electronically stored identification information, includes: scanning the items upon arrival of the items to a scanning location, the scanning location identifiable by scanning location information, by electronically reading the identification information stored on identification tag; sending the scanned information to a database to identify the item, the database having an index of all items to be tracked; storing the scanning location information in the database in relation to the identified item; displaying stored information in an electronic user interface; and selecting, without rescanning the identification tag, the item for distribution to another location.

### CROSS-REFERENCE TO RELATED APPLICATIONS

This application claims the benefit of provisional Application No. 61/110,908, filed Nov. 3, 2008, which is expressly incorporated herein in its entirety by reference thereto.

### FIELD OF THE INVENTION

The present invention relates to systems and methods for tracking distribution of items.

### BACKGROUND INFORMATION

Distribution tracking systems are used in the field to control and track inventory of items of manufacture that are shipped from place to place. Certain conventional distribution tracking systems, however, have not maximized the potential for providing a fast, convenient way for users to track and manage their inventory.

In certain conventional distribution tracking systems, when an item, e.g., a pallet, arrives at a location, for example, a retail location or a depot location, the item is scanned by the operator of the location. The item may then be sent to a bulk inventory, in the case of a depot location, where it is stored with other such items, or, in the case of a retail location, it is otherwise used in any manner required by the operator. The scanned information is retained in a database for the user of the system to access. When the item is to be shipped to another location, the item may be pulled from its present location and scanned a second time. The second scan logs information into the database as to the future location of the item of manufacture.

The system described above requires somewhat significant equipment and time, to both scan the item as it enters the location and scan it again as it is sent from the location. In particular, the second, outgoing scan may be time consuming for the operator, as the operator may be required to select a destination location from a list of potential destinations. The list of potential locations may be quite long, further extending the required time to complete a second, outgoing scan.

### SUMMARY

Example embodiments of the present invention provide a method for tracking the distribution of items, e.g., pallets, each item embedded with an identification tag storing electrically stored identification information. The tracking method is performed in a manner that may decrease necessary load time while maintaining or increasing control over the distribution. In this regard, the method eliminates the requirement of a second scan of the item prior to leaving its present location. That is, each item is scanned at the time that it is incoming to a location but not when it is outgoing from the location. Thus, the present method may be characterized as a single-scan method.

The method described herein is particularly applicable to the field of pallet pooling, which provides the ability for businesses to rent an exact number of pallets needed, rather than stocking sufficient pallets for, e.g., peak seasons, while allowing excess pallets to remain in storage during off-peak seasons. In a pallet pooling system, manufactures, distributors, retailers, etc., rent rather than own the pallets. The pallets are owner by a third party, e.g., the pallet owner. A pooled pallet system operates as follows: (1) the manufacturer notifies the pallet owner of a required shipment; (2) the pallet owner issues ready-for-use, e.g., plastic, pallets to the manufacturing facility in truckload quantities; (3) the manufacturer palletizes its product onto the platform and ships it down the distributor network; (4) distributors receive the pallets and either store the products in warehouses or use the pallets to move products to the retailer; (5) once the pallets have been emptied at a retail outlet, the distributor relocates the pallets to their distribution centers; (6) pallets are accumulated at the distribution center and the distributor returns the pallets to the pallet owner; and (7) the pallet owner inspects the pallets and prepares the pallets for reissue. Since the pallets are owned by the pallet owner and rented to its customers, it is important, both for asset tracking as well as for billing purposes, for the pallet owner to know the current location of the pallets as well as the location history of the pallets.

In the tracking method, each item is embedded with or include an identification tag, e.g., RFID tags, optically scannable, e.g., bar-coded, tags, etc., that carry, e.g., electronically- or optically-stored, identification information. When the items arrive at a location, such as a depot location or a retailer location, the operator at the location uses a scanning device, such as an RFID reader or optically scanner, to obtain the information that is stored in the identification tags from the tags to a database. This electronically stored information may include identification information for the item or may include any other information, such as a shipment history for the item.

Each scanning location can be identified by scanning location information. When an item is scanned at a location, the scanned information is used to identify the item to the database. The database stores the scanning location information into a shipment history for the scanned item. This process is repeated at every scanning location to which the item is sent. As a result, when an item is scanned at a scanning location, the previous shipment history is available to the operator via the database. The operator may view the shipping information on a monitor or any other display device. Once scanned, the item may then be stored in a temporary storage location, the temporary storage location information also being maintained in the database. The items may be grouped, at the temporary storage location, into so-called containers to simplify management of the items. The container may correspond to a physical container, e.g., a shipping container, or a physical location at a depot, e.g., a specific location on the floor of a warehouse, or the container may correspond to a logical container.

Once it is determined that an item is to be sent to another location, the outbound procedure, which does not include a second scanning operation, is followed. Using an interface device for display and input of information, an operator can select an item, a group of items, or a container of items, and indicate, through the interface, where the selected item or items should be sent. Once the future location is selected, the items may be sent to the future location without an additional, e.g., outgoing, scan. The outbound scanning information is not necessary to the procedure, as the database may be updated based on the information input by the operator. Once the items reach the future location, they may be scanned upon arrival at the future or next location, e.g., an incoming scan, and the process is repeated.

According to example embodiments of the present invention, a method of tracking distribution of items, each item including an identification tag including electronically stored identification information, includes: scanning the items upon arrival of the items to a scanning location, the scanning location identifiable by scanning location information, by electronically reading the identification information stored on identification tag; sending the scanned information to a database to identify the item, the database having an index of all items to be tracked; storing the scanning location information in the database in relation to the identified item; displaying stored information in an electronic user interface; and selecting, without rescanning the identification tag, the item for distribution to another location.

The method may include determining a shipment history of the items as a function of at least one of (a) previously scanned information and (b) previous scanning location information previously stored in the database.

The method may include classifying a transaction as one of (a) a return and (b) a transfer based on at least one of (a) a most recent scanning location in the shipping history and (b) a duration of time between successive scans of the item.

The scanning may be performed using RFID tags and an RFID reader.

The scanning may be performed using optical tags and an optical reader.

The item may be a pallet, e.g., a plastic pallet.

The items may be grouped into containers.

According to example embodiments of the present invention, a system for tracking distribution of items, each item including an identification tag including electronically stored identification information, includes: a scanning location identifiable by scanning location information; a database adapted to store information; an identification tag reader configured to electronically read the identification information stored on the identification tag and configured to send scanning location information and information scanned from the identification tag to the database; and an electronic user interface including a display unit adapted to display the stored information to a user and to allow the user to select the item for distribution to another location without scanning the identification tag of the item.

The identification tag may include an RFID tag, and the identification tag reader may include an RFID reader.

The identification tag may include an optical tag, and the identification tag reader may include an optical reader.

According to example embodiments of the present invention, a system includes: a plurality of items, each item including an identification tag including electronically stored identification information; and a device adapted to track distribution of the items. The device includes: a scanning location identifiable by scanning location information; a database adapted to store information; an identification tag reader configured to electronically read the identification information stored on the identification tag and configured to send scanning location information and information scanned from the identification tag to the database; and an electronic user interface including a display unit adapted to display the stored information to a user and to allow the user to select the item for distribution to another location without scanning the identification tag of the item.

In the discussion that follows, the items are referred to as pallets. The method described herein may be used in connection with plastic, reusable pallets, in that such pallets are often shipped to many locations, and perhaps carry a wide variety of products or other items. However, it should be understood that the system and method described herein may be used in connection with any other item.

Further features and aspects of example embodiments of the present invention are described in more detail below with reference to the appended Figures.

### BRIEF DESCRIPTION OF THE DRAWINGS

FIG. 1 schematically illustrates an exemplary item, e.g., a pallet, which may be used in connection with the method and system described herein.

FIG. 2 is a flow diagram of a method according to an example embodiment of the present invention.

### DETAIL DESCRIPTION

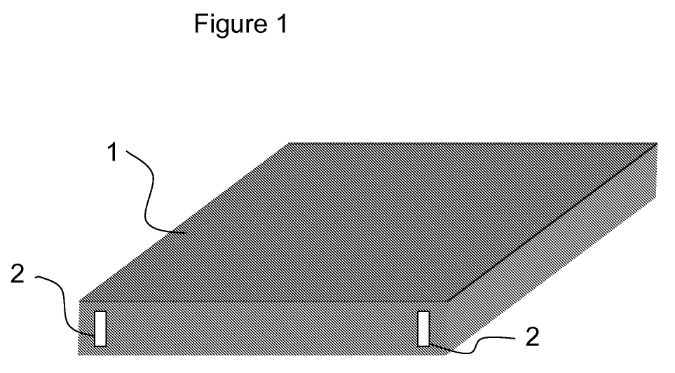

FIG. 1 schematically illustrates an item 1, e.g., a pallet 1. Pallet 1 is embedded with or includes identification tags 2 capable of storing electronic information. Tags 2 may be, e.g., RFID tags, optically scannable, e.g., bar code, tags, etc. Pallet 1 may be made of any suitable material, e.g., plastic. Plastic, as compared to traditional wooden pallets, is sturdier, readily washable and more easily maintained, so that the useful life of the pallet may be greatly increased. In addition, plastic keeps the identification tags well preserved and protected from damage.

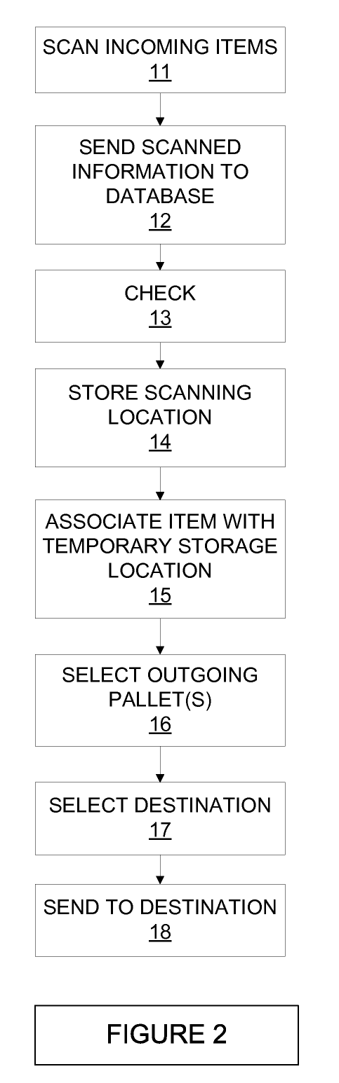

FIG. 2 is a flow diagram of a method according to an example embodiment of the present invention. In action 11, the incoming pallets are scanned using a reader, e.g., an RFID reader, an optical scanner, etc. The scanned information may include identification information, for identifying the particular pallet, or a pallet as part of a particular grouping of pallets, such as a container. In action 12, the scanned information is sent to an information database. The information database includes an index of all of the pallets that are in circulation in the network of pallets being tracked by the present method, e.g., all pallets of the pallet pool. The scanned pallet identification information is checked against the information database, in action 13, so as to identify the particular pallet or container of pallets being scanned.

In action 14, scanning location information is stored in the information database. Scanning location information may include information identifying the scanning location. This scanning location information is stored in the information database such that it is associated with the pallet or pallets identified in action 13. This scanning location information may include information identifying the type of scanning location, for example, as a retail location or a depot location. This stored scanning location information serves as a shipping history for the associated pallet or pallets. If the stored scanning location information includes the date and/or time of the incoming scan, it is also possible to track the duration of stay for each pallet at a given scanning location, e.g., for auditing, billing, accounting purposes, etc. The type of location and the duration of stay may be used, for example, by an operator or other user trying to determine the nature or length of the pallet's stay at a location, how the pallet was used at a location, etc.

A transaction may be classified according to the most recent scanning location information and the duration of stay. For example, a transaction may be classified as a return if the pallet is being sent from a retail location to a depot location, or a transfer if the pallet is being sent from one depot location to another, or from one retail location to another. Further, a pallet need not be sent to a depot location between shipments to retail locations. It is possible, to transfer pallets from one retail location to another. In this manner, greater efficiency of the pallet network may be attained.

Each pallet, in action 15, is associated with a temporary storage location until the pallet is assigned to a destination location. This temporary location may by the floor of a warehouse or particular location of the floor of the warehouse, a trailer for storage, a container, or any other location where the pallet may be found when it is requested to be moved. In action 16, when a pallet or container of pallets is requested to be shipped to a destination location, the operator can select a pallet or container of pallets using the interface. The interface includes data input devices, such as a keyboard or a mouse, along with a display. The operator, in action 17, may select a destination location for the pallet or container of pallets, without performing a subsequent, or outgoing, scan of the pallet or container of pallets. In action 18, the destination location information is stored in the information database, associated with the pallet or container of pallets, and the pallet or pallets are then sent to the destination location, again, without performing a subsequent, or outgoing, scan of the pallet or pallets. By eliminating the subsequent, or outgoing, scan, throughput or efficiency may be increased.

At the destination location, the process is started again at the scanning of incoming pallets at the destination location.

What is claimed is:

1. A method of tracking distribution of items, each item including an identification tag including electronically stored identification information, comprising:
scanning the items upon arrival of the items to a scanning location, the scanning location identifiable by scanning location information, by electronically reading the identification information stored on identification tag;
sending the scanned information to a database to identify the item, the database having an index of all items to be tracked;
storing the scanning location information in the database in relation to the identified item;
displaying stored information in an electronic user interface; and
selecting, without rescanning the identification tag, the item for distribution to another location.

2. The method of claim 1, further comprising determining a shipment history of the items as a function of at least one of (a) previously scanned information and (b) previous scanning location information previously stored in the database.

3. The method of claim 2, further comprising classifying a transaction as one of (a) a return and (b) a transfer based on at least one of (a) a most recent scanning location in the shipping history and (b) a duration of time between successive scans of the item.

4. The method of claim 1, wherein the scanning is performed using RFID tags and an RFID reader.

5. The method of claim 1, wherein the scanning is performed using optical tags and an optical reader.

6. The method of claim 1, wherein the item is a pallet.

7. The method of claim 1, wherein the item is a plastic pallet.

8. The method of claim 1, wherein the items are grouped into containers.

9. A system for tracking distribution of items, each item including an identification tag including electronically stored identification information, comprising:
a scanning location identifiable by scanning location information;
a database adapted to store information;
an identification tag reader configured to electronically read the identification information stored on the identification tag and configured to send scanning location information and information scanned from the identification tag to the database; and
an electronic user interface including a display unit adapted to display the stored information to a user and to allow the user to select the item for distribution to another location without scanning the identification tag of the item.

10. The system of claim 9, wherein the identification tag includes an RFID tag and the identification tag reader includes an RFID reader.

11. The system of claim 9, wherein the identification tag includes an optical tag and the identification tag reader includes an optical reader.

12. The system of claim 9, wherein the item is a pallet.

13. The system of claim 9, wherein the item is a plastic pallet.

14. A system, comprising:
a plurality of items, each item including an identification tag including electronically stored identification information; and
a device adapted to track distribution of the items, the device including:
a scanning location identifiable by scanning location information;
a database adapted to store information;
an identification tag reader configured to electronically read the identification information stored on the identification tag and configured to send scanning location information and information scanned from the identification tag to the database; and
an electronic user interface including a display unit adapted to display the stored information to a user and to allow the user to select the item for distribution to another location without scanning the identification tag of the item.
